(19) United States
(12) Patent Application Publication
(10) Pub. No.: US 2014/0063402 A1
(43) Pub. Date: Mar. 6, 2014

(54) LCD MODULE AND LCD DEVICE

(71) Applicant: Shenzhen China Star Optoelectronics Technology Co. Ltd., Shenzhen (CN)

(72) Inventors: Shihhsiang Chen, Shenzhen (CN); Gang Yu, Shenzhen (CN)

(73) Assignee: SHENZHEN CHINA STAR OPTOELECTRONICS TECHNOLOGY CO., LTD., Shenzhen (CN)

(21) Appl. No.: 13/643,076

(22) PCT Filed: Sep. 21, 2012
(86) PCT No.: PCT/CN12/81712

§ 371 Date: Oct. 23, 2012

(30) Foreign Application Priority Data
Aug. 31, 2012 (CN) 201210319092.0

(51) Int. Cl. G02F 1/1333

(52) U.S. Cl. CPC G02F 1/133308
USPC 349/58

(57) ABSTRACT

A liquid crystal display (LCD) module includes a backplane, a light source support arranged on at least one edge of the backplane, and a frame oppositely fixed to the backplane. An edge of the backplane where the light source support is arranged is not configured with a sidewall. The light source support is configured with at least one insertion slot having insertion an opening facing the frame, and the frame is configured with an insertion bar matching with the insertion slot.

### TECHNICAL FIELD

The present disclosure relates to the field of liquid crystal displays (LCDs), and more particularly to an LCD module and an LCD device.

### BACKGROUND

As a key component of a liquid crystal display (LCD) device, an LCD module is mainly used to provide sufficient brightness, uniformly distributed light sources, and display images.

As shown in FIG. 1 and FIG. 2, an LCD module of an LCD device includes a backplane 100, a lightbar 140 fixed to a sidewall of the backplane 100, a reflector plate 110 arranged on the backplane 100, a light guide panel (LGP) 120 arranged on the reflector plate 110, a middle frame 200a and a front frame 200b that are arranged outside the backplane 100 and pressed against the LGP 120. An optical film 130 is arranged on the light emitting surface of the LGP 120, and an LCD panel 300 is fixed on a backlight module by components including the middle frame 200a and the front frame 200b.

As shown in FIG. 2, an edge of the backplane 100 is configured with a sidewall 101, the middle frame 200a and the front frame 200b are fixed to the sidewall 101 of the backplane 100 via screw(s), and screw hole(s) is arranged in the sidewall 101 of the backplane 100. The lightbar 140 is configured with a light source support 145, and the lightbar 140 is further fixed to the sidewall 101 of the backplane 100 via the light source support 145. Because of existence of the light source support 145, the LCD device is not easy to be made with a narrower frame, and a light coupling distance is not easy to increase.

### SUMMARY

In view of the above-described problems, the aim of the present disclosure is to provide a liquid crystal display (LCD) module and an LCD device with the advantages of narrower frame and convenient installation.

The aim of the present disclosure is achieved by the following technical scheme. An LCD module comprises a backplane, a light source support arranged on at least one edge of the backplane, and a frame fixed relative to the backplane. The edge of the backplane where the light source support is arranged is not configured with a sidewall. The light source support is configured with at least one insertion slot having an insertion opening facing frame, and the frame is configured with an insertion bar matching with the insertion slot.

In one example, the insertion slot is internally configured with reverse fastener(s), and an end of the insertion bar is configured with reverse hook(s) engaged with the reverse fastener. The insertion bar is fixed in the insertion slot through the reverse fastener is engaged with the reverse hook.

In one example, the frame is a middle frame. The insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks. By arranging the two reverse fasteners which are oppositely arranged and the two reverse hooks which are correspondingly engaged with the two reverse fasteners, fixing reliability between the middle frame and the light source support is increased. Meanwhile, because the groove is arranged between the two reverse hooks, the reverse hooks of the insertion bar are easy to deform and easy to insert into the gap between the two reverse fasteners when the reverse hooks of the insertion bar are pressed against.

In one example, the light source support comprises a light source fixing plate. A side surface of the light source fixing plate facing the middle frame is configured with lug head(s), and the middle frame is configured with groove(s) used for insertion of the lug head(s). By inserting the lug head into the groove, the fixing reliability between the middle frame and the light source support is increased, and the middle frame is prevented from eversion.

In one example, thickness of the insertion slot is more than or equal to thickness of the insertion bar, and the entire insertion bar is in the insertion slot, so that the whole insertion bar is completely inserted into the insertion slot. Therefore, thickness of the insertion bar in the position of the frame is directly omitted, to enable the frame to be narrower.

In one example, the frame is a front frame. In some LCD modules without configuring with middle frame, or the middle frame is not fixed to the light source support but is connected with the sidewall at the edge of the backplane without configuring with the light source support, the front frame may be directly fixed to the light source support.

In one example, the insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks. By arranging the two reverse fasteners which are oppositely arranged and the two reverse hooks which are correspondingly engaged with the two reverse fasteners, the fixing reliability between the middle frame and the light source support is increased. Meanwhile, because the groove is arranged between the two reverse hooks, the reverse hooks of the insertion bar are easy to deform and easy to insert into the gap between the two reverse fasteners when the reverse hooks of the insertion bar are pressed against.

In one example, the light source support comprises a light source fixing plate. A side surface of the light source fixing plate facing the front frame is configured with lug head(s), and the front frame is configured with groove(s) used for insertion of the lug head. By inserting the lug head into the groove, fixing reliability between the front frame and the light source support is increased, and the front frame is prevented from eversion.

In one example, thickness of the insertion slot is more than or equal to thickness of the insertion bar, and the entire insertion bar is in the insertion slot, so that the whole insertion bar is completely inserted into the insertion slot. Therefore, the thickness of the insertion bar in the position of the frame is directly omitted, to enable the frame to be narrower.

An LCD device comprises the LCD module mentioned above.

In the present disclosure, because the edge of the backplane where the light source support is arranged is not configured with sidewall, the light source support is outwards moved, namely the frame of the LCD module is reduced by a thickness of the sidewall of the backplane, thereby achieving the narrower frame of the LCD module. Moreover, at least one pair of insertion bar and insertion slot which are mutually matched are arranged between the frame and the light source support to achieve mutual fixation. The insertion slot and the insertion bar are conveniently arranged, and only the frame is required to be depressed. Thus, complicated screws are not required for installation, thereby being beneficial to increase the installation efficiency of the LCD module. In addition, because the insertion bar of the frame is inserted into the insertion slot, the fixation mode may not increase thickness of the insertion bar too much or may not increase thickness of the insertion bar. Thickness of the frame is further reduced when omitting thickness of the sidewall.

### BRIEF DESCRIPTION OF FIGURES

FIG. 1 is a structural diagram of a typical LCD module;

FIG. 2 is a simplified sectional view of a typical LCD module;

FIG. 3 is a structural diagram of an LCD module of an example of the present disclosure;

FIG. 4A and FIG. 4B are structural change diagrams of a backplane and a light source support of an example of the present disclosure;

FIG. 5 is a simplified sectional view of an LCD module of an example of the present disclosure;

FIG. 6 is a thickness structural diagram of a middle frame and a light source support which are fixed of an example of the present disclosure;

FIG. 7 is a schematic diagram of a fixation mode of a middle frame or a front frame and a light source support of an example of the present disclosure;

FIG. 8 is a simplified structural diagram of a light source support of an example of the present disclosure;

FIG. 9 is one simplified structural diagram of a middle frame and a light source support of an example of the present disclosure;

FIG. 10 is another simplified structural diagram of a light source support of an example of the present disclosure;

FIG. 11 is a local structural diagram of another improved middle frame of an example of the present disclosure; and

FIG. 12 is a local structural diagram of another improved backplane of an example of the present disclosure.

Legends: 100. backplane; 101. sidewall; 102. insertion slot; 110. reflector plate; 120. LGP; 130. optical film; 140. lightbar; 145. light source support; 146. insertion slot; 147. reverse fastener; 148. lug head; 210. insertion bar; 211. reverse hook; 212. groove; 213. groove; 1450. light source fixing plate; 200. frame; 200a. middle frame; 200b. front frame; 300. LCD panel.

### DETAILED DESCRIPTION

The present disclosure will further be described in detail in accordance with the figures and the examples.

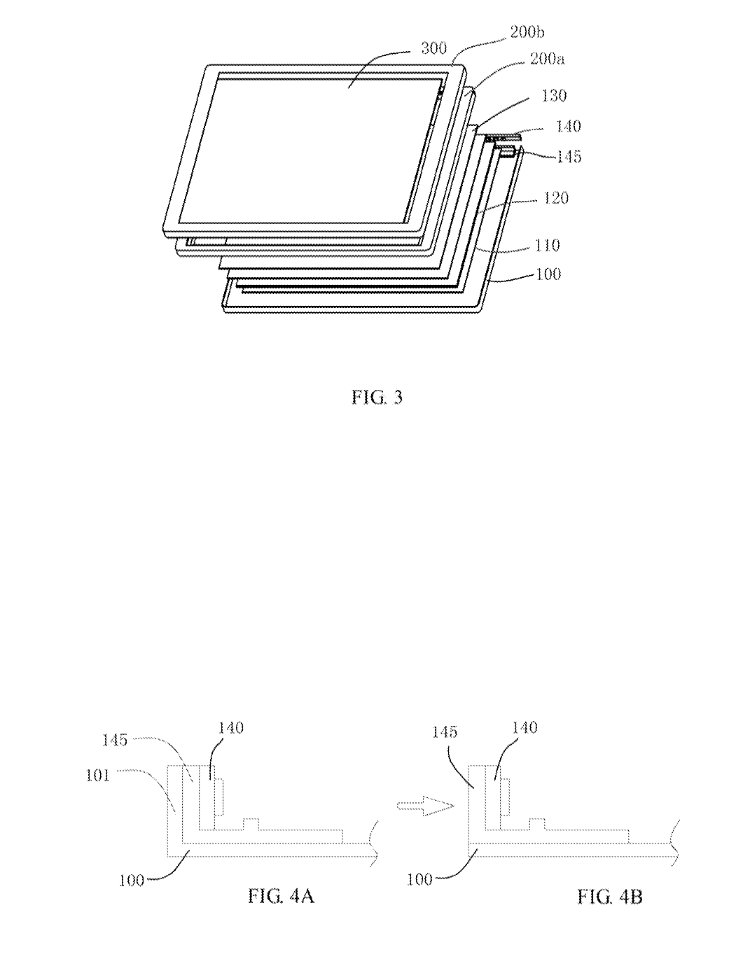

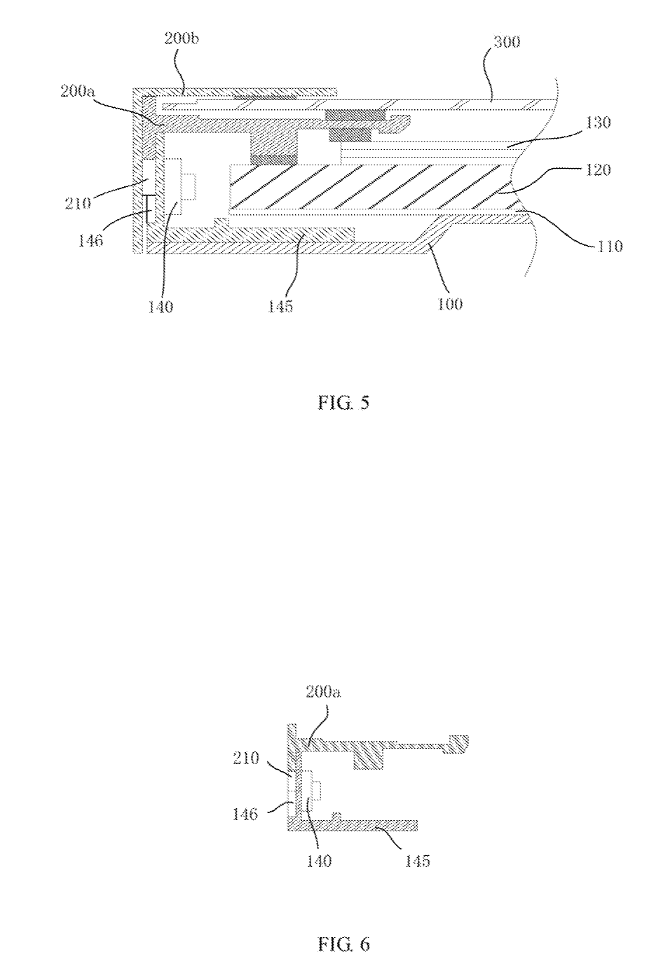

FIG. 3 and FIG. 5 show an exemplary example of the LCD module of the present disclosure. The LCD module comprises a backplane 100, a lightbar 140 fixed at one edge of the backplane 100, a reflector plate 110 arranged on the backplane 100, a light guide panel (LGP) 120 arranged on the reflector plate 110, and a frame 200 (a middle frame 200a or a front frame 200b) arranged on the backplane 100. An optical film 130 is arranged on an light emitting surface of the LGP 120, and an LCD panel 300 is fixed on a backlight module by components including the outer frame 200a (200), the front frame 200b (200). As shown in FIG. 4B, the lightbar 140 of the example is further configured with a light source support 145, and the lightbar 140 is fixed to the edge of the backplane 100 via the light source support 145. Because the edge of the backplane 100 where the light source support 145 is arranged is not configured with a sidewall 101 shown in FIG. 4A, the light source support 145 is moved outwards, namely the frame of the LCD module is reduced by thickness of the sidewall of the backplane, thereby making the frame of the LCD module narrower, and a light coupling distance between the LGP 120 and the lightbar 140 is increased, thereby increasing display quality.

Because the edge of the backplane 100 where the light source support 145 is arranged is not configured with sidewall, the fixation mode of the middle frame 200a or the front frame 200b is redesigned. As shown in FIGS. 5 to 8, taking the middle frame 200a as an example, the insertion slot 146 with an insertion opening facing the middle frame 200a is arranged on the light source support 145 and the insertion bar 210 is arranged on the middle frame 200a, the insertion slot 146 is internally configured with reverse fasteners 147, an end of the insertion bar 210 is configured with reverse hooks 211, and the reverse hooks 211 are mutually engaged with the reverse fasteners 147. Thus, the light source support 145 and the middle frame 200a can be fixed by the insertion bar 210 mutually matching with the insertion slot 146. The insertion slot 146 and the insertion bar 210 are conveniently arranged by using the matching mode between the insertion slot 146 and the insertion bar 210, and only the middle frame 200a is required to be depressed. Thus, complicated screws are not required for installation, thereby increasing installation efficiency of the LCD module.

As shown in FIG. 5, because the insertion bar 210 is inserted into the insertion slot 146, thickness of the light source support 145 and the insertion bar 210 is further reduced, and then thickness of the frame is further reduced. Alternatively, as shown in FIG. 6, thickness of the insertion slot 146 is equal to thickness of the insertion bar 210 or is more than thickness of the insertion bar 210, so that the entire insertion bar 210 is completely inserted into the insertion slot 146. Therefore, thickness of the insertion bar 210 in the position of the frame is directly omitted, to enable the frame to be narrower.

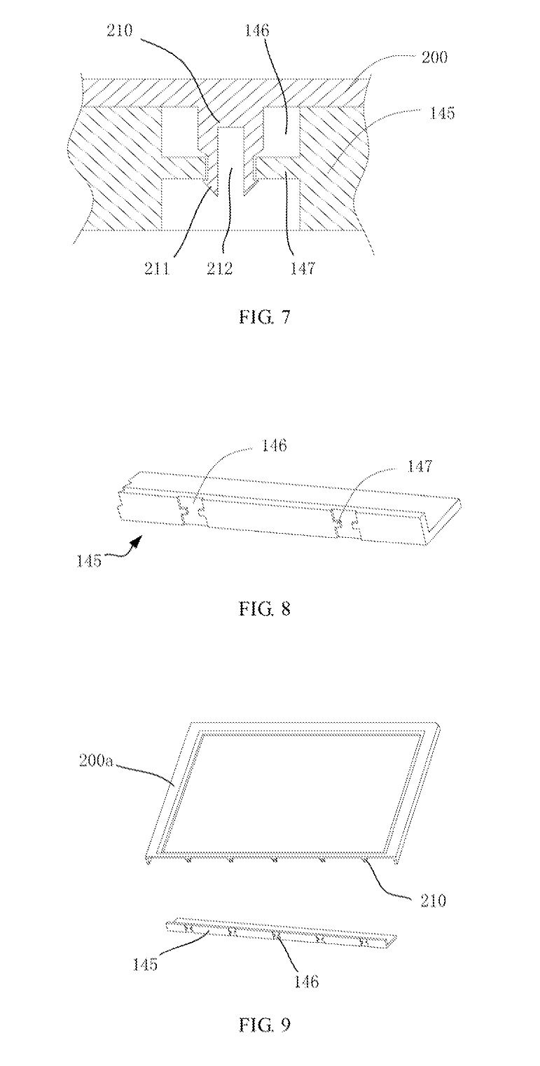

As shown in FIG. 7 and FIG. 8, in the example, the insertion slot 146 is configured with two reverse fasteners 147 which are oppositely arranged, the insertion bar 210 is configured with two opposite reverse hooks 211 which are oppositely arranged, and a groove 212 is arranged between the two reverse hooks 211. By arranging the two reverse hooks 147 which are oppositely arranged and two reverse hooks 211 which are correspondingly engaged with the two reverse fasteners 147, fixing reliability between the middle frame 200a and the light source support 145 increases. Meanwhile, because the groove 212 is arranged between the two reverse hooks 211, the reverse hooks 211 of the insertion bar 210 are easy to deform and easy to insert into the gap between the two reverse fasteners 147 when the reverse hooks 211 of the insertion bar 210 are pressed against.

FIG. 9 is a structural diagram of the middle frame 200a and the light source support 145. As can be seen from the diagram, the light source support 145 fixes the insertion bar 210 to the insertion slot 146 by inserting the insertion bar 210 into the insertion slot 146.

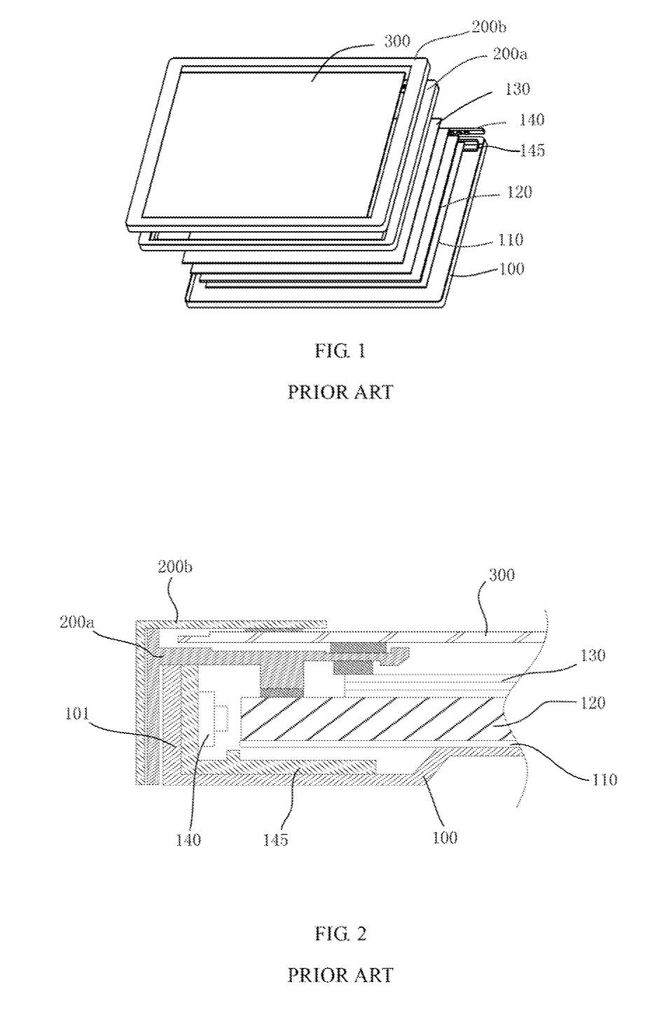

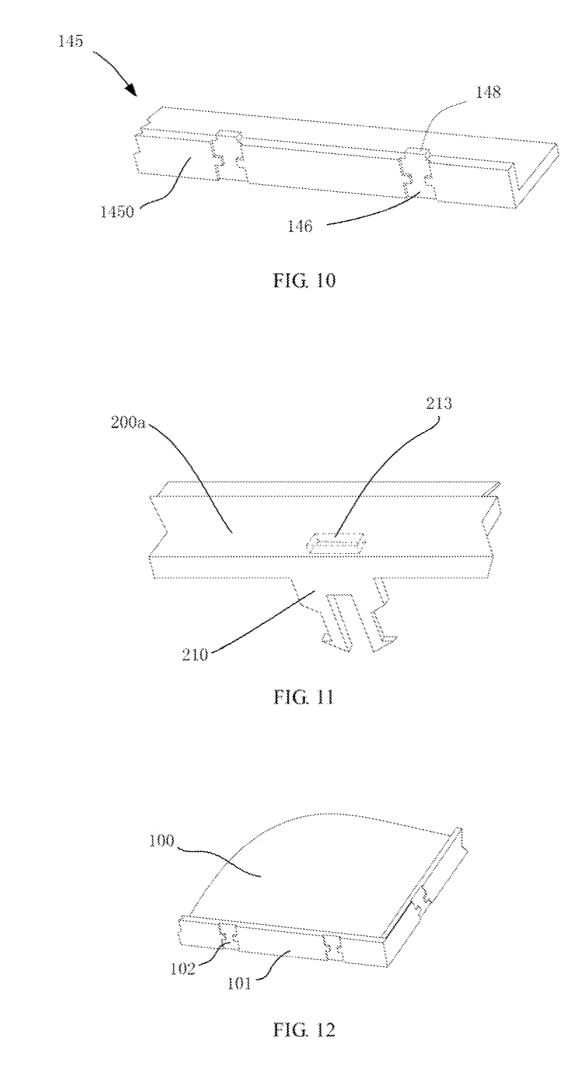

As shown in FIG. 10, the light source support 145 comprises a light source fixing plate 1450, and the side surface of the light source fixing plate 1450 facing the middle frame is configured with lug head(s) 148. As shown in FIG. 1, the inner side surface of the middle frame 200a (the side facing the light source support 145) is configured with groove(s) 213 for insertion of the lug head 148. By inserting the lug head 148 into the groove 213, fixing reliability between the middle frame and the light source support 145 is increased, and the middle frame 200a is prevented from eversion.

For the example, another improvement can be provided as well. As shown in FIG. 2, the edge of the backplane 100 where the light source support is arranged is configured with the sidewall 101, the sidewall 101 is configured with at least one insertion slot 102, and the insertion slot 102 is configured with reverse fasteners. Correspondingly, the middle frame is configured with an insertion bar matched with the insertion slot 102, and the end of the insertion bar is configured with insertion bar hooks engaged with the reverse fasteners. By further arranging the insertion slot 102 and insertion bar on the sidewall 101 of the backplane 100, the middle frame can be directly depressed to enable the insertion bar to be inserted into the corresponding insertion slot 102, and then the middle frame can he assembled. Thus, screws are not used for installation, and assembling material and assembling time are saved.

The present disclosure is described by taking the fixation mode between the middle frame and the light source support 145 as an example. Optionally, the frame 200 of the present disclosure further comprises a front frame. For some segmented middle frames (namely only the four corners of the LCD module are configured with L-shaped middle frames for supporting the LCD panel) or for some LCD modules without middle frames, the front frame can be fixed to the light source support 145 or the backplane by adapting the fixation mode shown in FIG. 7.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

1. A liquid crystal display (LCD) module, comprising:
backplane;
a light source support arranged on at least one edge of the backplane, the light source support comprising a light source fixing plate; and
a middle frame fixed relative to the backplane;
wherein an edge of the backplane where the light source support is arranged is not configured with a sidewall, the light source support is configured with at least one insertion slot having an insertion opening facing the frame, and the middle frame is configured with an insertion bar matching with the insertion slot;
wherein the insertion slot is internally configured with two opposite reverse fasteners, an end of the insertion bar is configured with two opposite reverse hooks which are correspondingly engaged with the reverse fasteners, and a groove is arranged between the two reverse hooks; and
wherein a side surface of the light source fixing plate facing the middle frame is configured with lug head(s), and the middle frame is configured with groove(s) used for insertion of the lug head.

2. A liquid crystal display (LCD) module, comprising:
backplane;
a light source support arranged on at least one edge of the backplane; and
a frame fixed relative to the backplane;
wherein an edge of the backplane where the light source support is arranged is not configured with a sidewall, the light source support is configured with at least one insertion slot having insertion an opening facing the frame, and the frame is configured with an insertion bar matching with the insertion slot.

3. The LCD module of claim 2, wherein the insertion slot is internally configured with reverse fastener(s), and an end of the insertion bar is configured with reverse hook(s) engaged with the reverse fastener.

4. The LCD module of claim 3, wherein the frame is a middle frame; the insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks.

5. The LCD module of claim 4, wherein the light source support comprises a light source fixing plate; a side surface of the light source fixing plate facing the middle frame is configured with lug head(s), and the middle frame is configured with groove(s) used for insertion of the lug head.

6. The LCD module of claim 4, wherein thickness of the insertion slot is more than or equal to thickness of the insertion bar, and the entire insertion bar is in the insertion slot.

7. The LCD module of claim 3, wherein the frame is a front frame.

8. The LCD module of claim 7, wherein the insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks.

9. The LCD module of claim 7, wherein the light source support comprises a light source fixing plate; the side surface of the light source fixing plate facing the front frame is configured with lug head(s), and the front frame is configured with groove(s) used for insertion of the lug head.

10. The LCD module of claim 7, wherein the thickness of the insertion slot is at least more than or equal to thickness of the insertion bar, and the entire insertion bar is in the insertion slot.

11. A liquid crystal display (LCD) device, comprising:
backplane;
a light source support arranged on at least one edge of the backplane; and
a frame fixed relative to the backplane;
wherein an edge of the backplane where the light source support is arranged is not configured with a sidewall, the light source support is configured with at least one insertion slot having an insertion opening facing the frame, and the time is configured with an insertion bar matching with the insertion slot.

12. The LCD device of claim 11, wherein the insertion slot is internally configured with reverse fastener(s), and an end of the insertion bar is configured with reverse hook(s) engaged with the reverse fastener.

13. The LCD device of claim 12, wherein the frame is a middle frame; the insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks.

14. The LCD device of claim 13, wherein thickness of the insertion slot is at least more than or equal to thickness of the insertion bar, and the entire insertion bar is in the insertion slot.

15. The LCD device of claim 13, wherein the light source support comprises a light source fixing plate; a side surface of the light source fixing plate facing the middle frame is configured with lug head(s), and the middle frame is configured with groove(s) used for insertion of the lug head.

16. The LCD device of claim 15, wherein thickness of the insertion slot is at least more than or equal to thickness of the insertion bar, and the entire insertion bar is in the insertion slot.

17. The LCD device of claim 12, wherein the frame is a front frame.

18. The LCD device of claim 17, wherein the insertion slot is internally configured with two reverse fasteners which are oppositely arranged, the insertion bar is configured with two opposite reverse hooks which are correspondingly engaged with the two opposite reverse fasteners, and a groove is arranged between the two reverse hooks.

19. The LCD device of claim 17, wherein the light source support comprises a light source fixing plate; the side surface of the light source fixing plate facing the front frame is configured with lug head(s), and the from frame is configured with groove(s) used for insertion of the lug head.

20. The LCD device of claim 17, wherein thickness of the insertion slot is at least more than or equal to thickness of the insertion bar, and the entire insertion bar is in the insertion slot.
